(19) United States
(12) Patent Application Publication
(10) Pub. No.: US 2010/0195432 A1
(43) Pub. Date: Aug. 5, 2010

(54) POURING AND MIXING LID FOR CYLINDRICAL CONTAINERS

(76) Inventors: Kevin Laurence, Encino, CA (US); Stuart Long, Camarillo, CA (US)

Correspondence Address: ITALIA IP, 3500 WEST OLIVE AVE., SUITE 300, BURBANK, CA, 91505, US

(21) Appl. No.: 12/364,489

(22) Filed: Feb. 2, 2009

(51) Int. Cl. B65D 51/18; B01F 7/00; B01F 15/02; B01F 15/00; B01F 13/06

(52) U.S. Cl. 366/139; 220/257.2; 366/244; 366/181.6; 366/143

(57) ABSTRACT

A cover for blending one or more materials in an open topped container. The cover is adapted to close the open top during blending. The cover may have a central hole for passing the shaft of a powered blender and a peripheral opening for pouring materials from the container or into a container, and to view the progress of the mixing. Optionally, the cover may have a third opening and as a further option, a fourth opening, the third and fourth openings adapted to connect to a commercial vacuum device for evacuating dust from the container during blending. The third and fourth openings may be formed as prescored removable portions of the cover. In a further option, the third and fourth openings may be provided with close fitting removable resilient plugs. The upper surface of the cover may be inclined so that liquids flow towards the peripheral opening and into the container.

### BACKGROUND OF THE INVENTION

1. Field of the Invention

The present invention relates to lids for general purpose containers, which are typically cylindrical, to adapt such containers for mixing fluid contents and dispensing the contents by pouring.

2. Background of the Invention

Consumer, commercial, industrial, and institutional products may be provided in commonly used or standard sizes. For example, five gallon plastic buckets are frequently used by retailers and others to contain detergents, building materials, paint, and other products. These buckets are typically quite sturdy and are retained by users after the original contents have been consumed. These buckets may be utilized for storage, transport of tools, materials, and other objects, and may be utilized for preparing small quantities of consumable materials.

One use for such buckets is preparation of plaster, cement, concrete, mortar, and grout for use in small construction or repair projects. While such buckets are economical if reused in this manner, and provide a convenient device for mixing up materials for small construction and repair projects, they nonetheless have certain shortcomings.

One problem is that it is not easy to pour a very small quantity of mixed fluid material from a standard five gallon bucket. Another is that the materials cited above generate considerable dust until they are fully mixed with the liquid, such as water, which they must be blended.

There exists a need in the prior art for rendering standard containers more suitable for mixing and pouring blended fluid products which have been mixed therein.

### SUMMARY OF THE INVENTION

In one aspect, the present invention provides an accessory for standard and other containers which address the above stated needs. In another aspect, the present invention provides a way to mix materials in standard and other containers while suppressing dust or liquids.

A cover adapted to close a container may have openings to pass the shaft of a paddle type blender, so that materials may be mixed inside container using a mixer while still being mostly closed. An opening enables materials to be poured under control from the container or into a container and to view the progress of the mixing. Optional openings enable a vacuum device to be connected to the container during blending or mixing so that dust or liquids may be collected and suppressed. The optional openings may be formed by pre-scored lines so that they may be removed by force, leaving openings of predetermined locations and configuration. The optional opening may be separated or concentric. The optional openings may be provided with resilient plugs so they may be repeatedly used and reclosed.

It is therefore an object of the invention to provide a cover for a container which enables a mixing device to penetrate the cover, thereby conducting blending while the cover closes the container.

Another object of the invention is to form a pouring guide in the cover of the container.

A further object of the invention is to promote containment or suppression of dust or liquid while blending materials within a container.

Still another object of the invention is to convert pre-existing standard containers to the purpose of mixing and pouring fluids while enabling suppression of dust and liquids.

It is an object of the invention to provide improved elements and arrangements thereof by apparatus for the purposes described which is inexpensive, dependable, and fully effective in accomplishing its intended purposes.

These and other objects of the present invention will become readily apparent upon further review of the following specification and drawings.

### BRIEF DESCRIPTION OF THE DRAWINGS

Various objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of a generally cylindrical container with a cooperating cover according to at least one aspect of the invention.

FIG. 2 is an environmental side view of a cover according to at least one aspect of the invention fitted to a generally cylindrical container, with a hand drill operated blending paddle passing through the cover and extending into the container.

FIG. 3 is a top plan view of a cover according to at least one aspect of the invention.

FIG. 4 is a cross sectional detail view of a cover according to at least one aspect of the invention, shown installed over a container.

FIG. 5 is a cross sectional detail view of a cover according to at least one further aspect of the invention, shown installed over a container.

FIG. 6 is a perspective view of a cover according to at least one aspect of the invention.

FIG. 7 is an environmental side view of a container enclosed by a cover according to at least one aspect of the invention and shown connected to a vacuum device.

### DETAILED DESCRIPTION

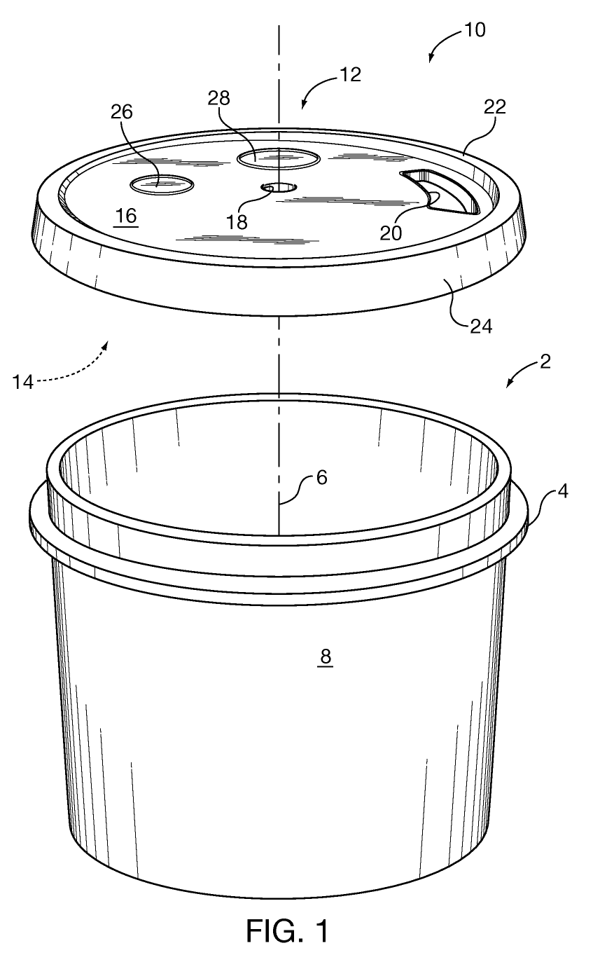

FIG. 1 shows a container 2 and a cover 10 for promoting blending and dispensing of liquids within the container 2. The cover 10 may comprise a platform 12 which essentially spans the upper open area of the container 2. The platform 12 has an inner side 14 which faces the receptacle or interior of the container 2 and an outer side 16 which faces away from the interior of the container 2. The orientations defining the inner side 14 and outer side 16 of the platform 12 will be understood to be so defined when the cover 10 is in an operable position installed on the container 2, as seen for example in FIG. 4. In FIG. 1, the cover 10, if lowered would assume the operable position covering the open end of the container 2 when fully seated on the container 2. The container 2 may be for example a five gallon pail of the type widely used to contain small quantities of bulk construction and building repair materials, such as plaster, joint compound, and paint, and other consumer materials such as detergent. The container 2 may have a rib 4 disposed to oppose collapse of the container 2 when lifted, and may or may not include a bail type or other handle (not shown).

The cover 10 may have a central opening 18 which passes entirely through the platform 12. The central opening 18 may be located coaxially with the opening and receptacle of the container 2. As depicted, the central axis 6 of the container 2 also defines the center of the central opening 18. The platform may also be angled toward the central opening 18 to assist in materials being added to the container. This angled platform will allow materials to “drain” toward the central opening 18 like a funnel and into the container 2 (not shown).

A peripheral opening 20 located generally at the periphery of the platform 12 may be used as a pouring spout to dispense materials (not shown) which have been mixed in the container 2, for adding materials to the container 2, and for viewing the progress of the mixing. It will be seen that the peripheral opening 20 is longer along the circumference of the container 2 than it is in the radial direction. The radial direction is defined as starting at the center of the cover and extending towards the outer wall 8 of the container 2 in a direction perpendicular to the axis 6. It is contemplated that the peripheral opening 20 may be of any shape sufficient for the purpose of pouring materials from the container, adding materials to the container, or viewing the progress of the mixing within the container.

A short wall 22 may project from the platform 12 along at least part of the periphery of the platform 12 outside the peripheral opening 20 on the outer side of the platform 12, as shown in FIG. 1. The short wall 22 may if desired be extended to project from the platform 12 along the full extent of the periphery of the platform 12 (this option is not shown).

A mounting lip 24 may project from the inner side 14 of the platform 12. The mounting lip 24 extends from the platform 12 in a direction opposite from that of the short wall 22. As depicted in FIG. 1, the short wall 22 and the mounting lip 24 are coextensive, so that there is no visual line of demarcation visible in FIG. 1. The mounting lip 22 is dimensioned and configured to engage the open end of the container 2 in close cooperation therewith such that the cover 10 is manually installable on and removable from the container 2.

The platform 12 may occupy a plane which is oriented out of perpendicularity with the short wall 22, as shown in FIG. 1. The peripheral opening 20 of the platform 12 is located at the tallest portion of the short wall 22 such that the upper surface 16 of the cover is inclined so that liquids or other materials flow towards the peripheral opening 20 and into the container 2. This arrangement also enables the cover 10 to serve as a pouring spout should a person desire to dispense fluid or other contents contents from the container 2 with the cover 10 fully installed. Pouring will be at a rate restricted and more controllable than if pouring from the fully open container 2 in the absence of the cover 10.

As described above, the central opening 18 and peripheral opening 20 go through the platform 12 of the cover, however, it is contemplated that the two opening can be in the state of prescored frangible closures that may be broken away from the platform 12 by force, such as by impact of a hammer or cut away with a blade (not shown) to the form respective central opening 18 and peripheral opening 20. This structure is described further below with respect to additional openings.

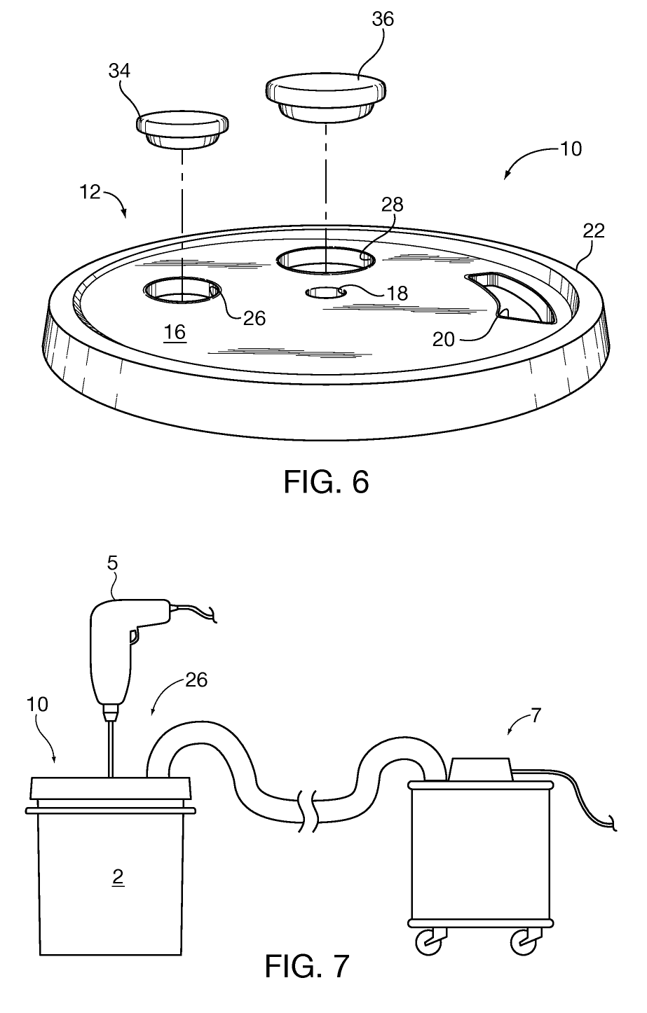

Two additional openings may be formed in the cover 10 if desired. Each one of the two additional openings may be formed as prescored frangible closures 26, 28 formed in the platform 12. Each prescored frangible closure 26 or 28 may be broken away from the platform 12 by force, such as by impact of a hammer or cut away with a blade (not shown) to form respective first and second additional openings, such as the openings of FIG. 6, which pass through the platform 12.

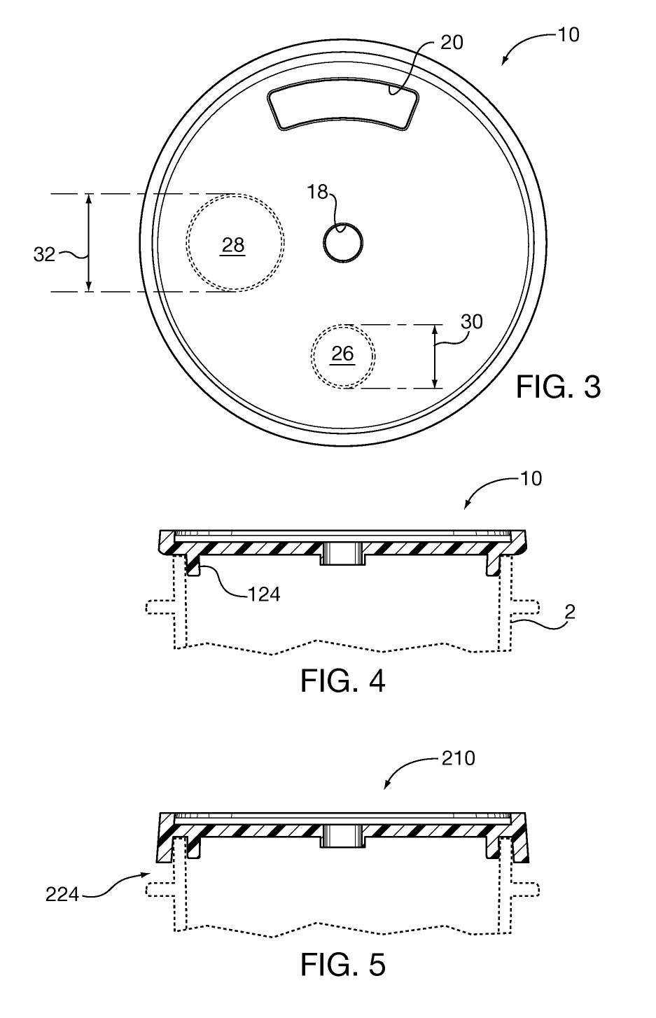

Preferably, the prescored frangible closure 26 and the resultant opening which would be formed by removal of the closure 26 is of cross sectional area which is different from those of the closure 28. The prescored frangible closures 26, 28 and their resultant openings may be circular as depicted, with different diameters 30, 32 (see FIG. 3). Alternatively, the prescored frangible closures 26, 28 with different diameters 30, 32 may be concentric (not shown) rather than separate as shown.

FIGS. 4 and 5 show alternative arrangements of respective covers 110, 210. In FIG. 4, a cover 110, which in other ways may be the structural and functional equivalent of the cover 10, has a mounting lip 124 arranged to have an exterior diameter which is smaller than that of the container 2 on which the cover 110 may be installed.

In FIG. 5, a cover 210, which in other ways may be the structural and functional equivalent of the cover 10, has a mounting lip 224 arranged to have an interior member and an exterior member which collectively surround the wall of the container 2 on which the cover 210 may be installed.

Regardless of the arrangement of the mounting lip, such as the mounting lips 24, 124, 224, a cover according to at least one aspect of the present invention, such as the cover 10, may be circular, and dimensioned and configured to engage and fit to a standard generally cylindrical five gallon pail having an exterior diameter of about eleven and one half inches to twelve inches at the opening. Alternatively, dimensions of a cover such as the cover 10 may be modified so that the resultant cover is dimensioned and configured to engage and fit to a standard generally cylindrical one gallon paint can having an exterior diameter of about six and one half inches to seven inches at the opening.

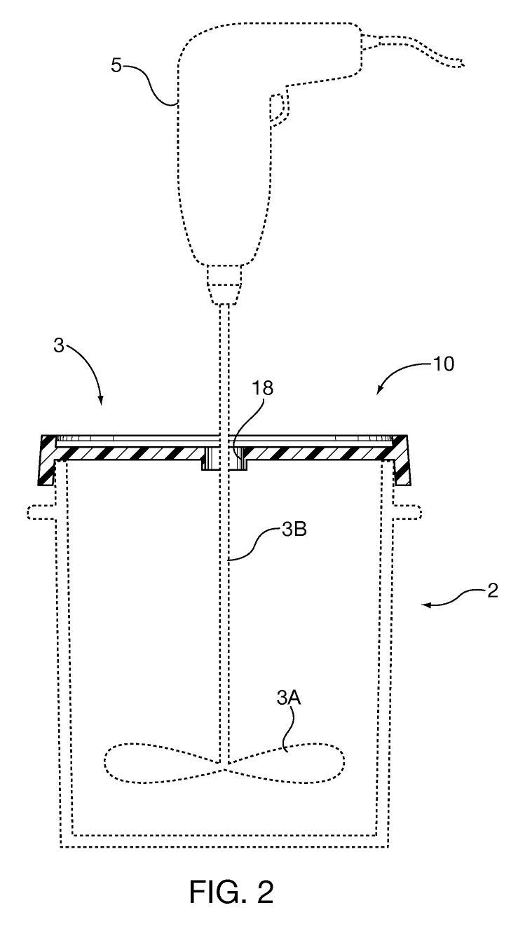

FIG. 2 shows one way in which the cover 10 may be used. A mixing paddle 3A of a mixing blender 3 is inserted by its shaft 3B into an electric hand drill 5. The shaft 3B is inserted through the central opening 18 of the cover 10. Water and a material to be mixed with water (neither shown) have been loaded into the container 2 prior to assembly of the mixing paddle 3, the hand drill 5, and the cover 10. The hand drill 5 may then be operated to mix the contents of the container 2.

FIG. 6 shows an optional closure system for additional openings of a cover according to at least one aspect of the invention, such as the additional openings 26, 28 of the cover 10. The additional opening 26 may be provided with a resilient plug 34, such as one made from rubber, silicone, or a resilient elastomer, which is dimensioned and configured to be removably inserted within and close the additional opening 26. Similarly, the additional opening 28 may be provided with a resilient plug 36 which is dimensioned and configured to be removably inserted within and close the additional opening 28.

FIG. 7 illustrates one possible use for an additional opening, such as the additional opening 26. The hose of a canister type vacuum device 7, which may be of any known commercial canister type vacuum device having a filter (not shown) arranged to filter ejected air, or which may be of another type vacuum cleaner for example, is inserted into the additional opening 26 (not visible in the side view of FIG. 7). The mixing blender 3 may be assembled as described with reference to FIG. 2. Water and a material to be mixed with water (neither shown) have been loaded into the container 2 prior to assembly of the mixing paddle 3. If the material to be mixed with water is a powdered product prone to generate dust, such as plaster, cement, and the like, for example, then dust may be evacuated and suppressed by using the vacuum device 7 while mixing the contents of the container 2.

Dust may be further suppressed by installing a plug such as the plugs 34 and 36 into any unused opening formed in the cover 10.

The invention may be viewed as a method of suppressing dust when mixing a powdered product with a liquid in a container, as described with reference to FIG. 7. The method may comprise the steps of providing a container having an open end, such as the container 2; providing a cover such as the cover 10, which fits over the open end of the container and has a first opening and a second opening, such as the openings 18 and 20; connecting a vacuum device having a filter, such as the vacuum device 7, to one of the first opening and the second opening, such as the appropriately sized additional opening 2i6 or 28; and mixing the powdered product with a liquid in the container 2 while using the vacuum device to evacuate and trap dust from the container 2. The method may comprise the further steps of passing the shaft of a mixing blender having a shaft and a blending paddle, such as the mixing blender 3, through one of the first opening and the second opening such that the paddle 3B is immersed in the liquid with which the powdered product is to be blended, and rotating the blending paddle to mix the powdered product with the liquid while operating the vacuum device. Mixing of a potentially dust generating process is thereby eliminated or greatly diminished.

The present invention is susceptible to modifications and variations which may be introduced thereto without departing from the inventive concepts. For example, although the invention has been described with respect to containers which are circular in cross section, such as the container 2, a cover according to at least one aspect of the invention may be configured to cooperate with other containers, such as rectangular, rectangular with radiused or rounded corners, and others.

Also, substances being mixed may be other than powder. Paint, fertilizer compositions, soil compositions, adhesives, solvents, lubricants, hardenable substances such as binary epoxy compositions, clay and other slurries, foods, and still other substances may be mixed using the novel apparatus and method steps described herein.

It would also be possible to mix particulate materials, such as seeds, ceramic glazing compositions, particulate or pellet plastic feedstock, and others, in the absence of liquids using the novel apparatus and method or both.

Dust containment or suppression need not play a role in using the present invention. The novel apparatus may be utilized to provide, together with an open container, a convenient receptacle for mixing a fluid mixture, pouring a fluid mixture, or both.

While the present invention has been described in connection with what is considered the most practical and preferred embodiment, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A cover for promoting blending of one or more materials within a container, comprising a platform disposed to cover the open end of the container, wherein
the platform comprises:
an inner side which faces the interior of the container when the cover is mounted on the container,
an outer side which faces away from the interior of the container when the cover is mounted on the container,
a central opening passing through the platform,
a peripheral opening passing through the platform,
the cover further comprises
a short wall projecting from the platform along at least part of the periphery of the platform outside the peripheral opening on the outer side of the platform, and
a mounting lip projecting from the inner side of the platform, wherein the mounting lip is dimensioned and configured to engage the open end of the container in close cooperation therewith.

2. The cover of claim 1, wherein the short wall extends only partly along the circumference of the cover.

3. The cover of claim 1, wherein the platform occupies a plane which is oriented out of perpendicularity with the short wall, and wherein the peripheral opening of the platform is located at the tallest portion of the short wall, such that outer side of the cover is inclined so that liquids or other materials flow towards the peripheral opening and into the container.

4. The cover of claim 1, further comprising a first prescored frangible closure formed in the platform, which may be removed from the platform to form a first additional opening passing through the platform.

5. The cover of claim 4, further comprising a second prescored frangible closure formed in the platform, which may be removed from the platform to form a second additional opening passing through the platform, wherein the second additional opening has a cross sectional area different from that of the first additional opening.

6. The cover of claim 4, further comprising a resilient plug which is dimensioned and configured to be removably inserted within and close the first additional opening.

7. The cover of claim 5, further comprising a second resilient plug which is dimensioned and configured to be removably inserted within and close the second additional opening.

8. The cover of claim 1, wherein the cover is circular and is dimensioned and configured to engage and fit to a standard generally cylindrical five gallon pail having an exterior diameter of about eleven and one half inches to twelve inches at the opening.

9. The cover of claim 1, wherein the cover is circular and is dimensioned and configured to engage and fit to a standard generally cylindrical one gallon paint can.

10. The cover of claim 1, further comprising a first additional opening passing through the platform.

11. The cover of claim 10, further comprising a second additional opening passing through the platform, wherein the second additional opening has a cross sectional area different from that of the first additional opening.

13. The cover of claim 10, further comprising a resilient plug which is dimensioned and configured to be removably inserted within and close the first additional opening.

14. The cover of claim 11, further comprising a second resilient plug which is dimensioned and configured to be removably inserted within and close the second additional opening.

15. A method of containing one or more materials while mixing in a container, comprising the steps of:
providing a container having an open end;
providing a cover which fits over the open end of the container and has a central opening and one or more peripheral openings;
passing the shaft of a mixing blender having a shaft and a blending paddle through the central opening such that the paddle is immersed in material which is to be blended; and
rotating the blending paddle to mix the material or materials.

16. The method of claim 15, comprising the further step of:
adding additional material through one of said peripheral openings.

17. The method of claim 16, comprising the further step of:
viewing the progress of the mixing process through one of said peripheral openings.

18. The method of claim 17, comprising the further step of:
connecting a vacuum device to one of said peripheral openings.

19. The method of claim 15, comprising the further step of:
viewing the progress of the mixing process through one of said peripheral openings.

20. The method of claim 19, comprising the further step of:
connecting a vacuum device to one of said peripheral openings.
